(19) United States
(12) Patent Application Publication
(10) Pub. No.: US 2024/0155323 A1
(43) Pub. Date: May 9, 2024

(54) SYSTEM INFORMATION AND PAGING FORWARDING IN RELAY

(71) Applicant: QUALCOMM Incorporated, San Diego, CA (US)

(72) Inventors: Peng CHENG, Beijing (CN); Karthika PALADUGU, Hyderabad (IN); Masato KITAZOE, Hachiouji-shi (JP); Ozcan OZTURK, San Diego, CA (US); Hong CHENG, Basking Ridge, NJ (US)

(21) Appl. No.: 18/576,282

(22) PCT Filed: Aug. 17, 2021
(86) PCT No.: PCT/CN2021/112914

§ 371 Date: Jan. 3, 2024

(51) Int. Cl. H04W 8/00; H04W 48/20; H04W 68/02; H04W 76/19; H04W 76/20

(52) U.S. Cl. CPC H04W 8/005; H04W 48/20; H04W 68/02; H04W 76/19; H04W 76/20

(57) ABSTRACT

Various aspects of the present disclosure generally relate to wireless communication. In some aspects, a user equipment (UE) may receive, from a relay device associated with a serving cell, a discovery message including a system information block with an identifier associated with the serving cell. Accordingly, the UE may determine, using the identifier associated with the serving cell, a global identity associated with a base station of the serving cell. In some aspects, a UE may determine a radio resource control state associated with the UE. Accordingly, the UE may transmit, to a relay device, a paging configuration associated with the UE. Numerous other aspects are described.

### FIELD OF THE DISCLOSURE

Aspects of the present disclosure generally relate to wireless communication and to techniques and apparatuses for system information and paging forwarding in relay.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to receive, from a relay device associated with a serving cell, a discovery message including a system information block (SIB) with an identifier associated with the serving cell. The one or more processors may be further configured to determine, using the identifier associated with the serving cell, a global identity (gNB ID) associated with a base station of the serving cell.

Some aspects described herein relate to an apparatus for wireless communication at a relay device. The apparatus may include a memory and one or more processors coupled to the memory. The one or more processors may be configured to receive, from a base station in a serving cell, an SIB including an identifier associated with the serving cell. The one or more processors may be further configured to transmit, to a UE, a discovery message including the SIB with the identifier.

Some aspects described herein relate to an apparatus for wireless communication at a UE. The apparatus may include a memory and one or more processors coupled to the memory. The one or more processors may be configured to determine a radio resource control (RRC) state associated with the UE. The one or more processors may be further configured to transmit, to a relay device, a paging configuration associated with the UE.

Some aspects described herein relate to an apparatus for wireless communication at a relay device. The apparatus may include a memory and one or more processors coupled to the memory. The one or more processors may be configured to receive, from a UE, a paging configuration associated with the UE and an RRC state associated with the UE. The one or more processors may be further configured to determine whether to monitor paging occasions for the UE based at least in part on the paging configuration.

Some aspects described herein relate to a method of wireless communication performed by a UE. The method may include receiving, from a relay device associated with a serving cell, a discovery message including an SIB with an identifier associated with the serving cell. The method may further include determining, using the identifier associated with the serving cell, a global gNB ID associated with a base station of the serving cell.

Some aspects described herein relate to a method of wireless communication performed by a relay device. The method may include receiving, from a base station in a serving cell, an SIB including an identifier associated with the serving cell. The method may further include transmitting, to a UE, a discovery message including the SIB with the identifier.

Some aspects described herein relate to a method of wireless communication performed by a UE. The method may include determining an RRC state associated with the UE. The method may further include transmitting, to a relay device, a paging configuration associated with the UE.

Some aspects described herein relate to a method of wireless communication performed by a relay device. The method may include receiving, from a UE, a paging configuration associated with the UE and an RRC state associated with the UE. The method may further include determining whether to monitor paging occasions for the UE based at least in part on the paging configuration.

Some aspects described herein relate to a non-transitory computer-readable medium that stores a set of instructions for wireless communication by a UE. The set of instructions, when executed by one or more processors of the UE, may cause the UE to receive, from a relay device associated with a serving cell, a discovery message including an SIB with an identifier associated with the serving cell. The set of instructions, when executed by one or more processors of the UE, may further cause the UE to determine, using the identifier associated with the serving cell, a global gNB ID associated with a base station of the serving cell.

Some aspects described herein relate to a non-transitory computer-readable medium that stores a set of instructions for wireless communication by a relay device. The set of instructions, when executed by one or more processors of the relay device, may cause the relay device to receive, from a base station in a serving cell, an SIB including an identifier associated with the serving cell. The set of instructions, when executed by one or more processors of the relay device, may further cause the relay device to transmit, to a UE, a discovery message including the SIB with the identifier.

Some aspects described herein relate to a non-transitory computer-readable medium that stores a set of instructions for wireless communication by a UE. The set of instructions, when executed by one or more processors of the UE, may cause the UE to determine an RRC state associated with the UE. The set of instructions, when executed by one or more processors of the UE, may further cause the UE to transmit, to a relay device, a paging configuration associated with the UE.

Some aspects described herein relate to a non-transitory computer-readable medium that stores a set of instructions for wireless communication by a relay device. The set of instructions, when executed by one or more processors of the relay device, may cause the relay device to receive, from a UE, a paging configuration associated with the UE and an RRC state associated with the UE. The set of instructions, when executed by one or more processors of the relay device, may further cause the relay device to determine whether to monitor paging occasions for the UE based at least in part on the paging configuration.

Some aspects described herein relate to an apparatus for wireless communication. The apparatus may include means for receiving, from a relay device associated with a serving cell, a discovery message including an SIB with an identifier associated with the serving cell. The apparatus may further include means for determining, using the identifier associated with the serving cell, a global gNB ID associated with a base station of the serving cell.

Some aspects described herein relate to an apparatus for wireless communication. The apparatus may include means for receiving, from a base station in a serving cell, an SIB including an identifier associated with the serving cell. The apparatus may further include means for transmitting, to a UE, a discovery message including the SIB with the identifier.

Some aspects described herein relate to an apparatus for wireless communication. The apparatus may include means for determining an RRC state associated with the apparatus. The apparatus may further include means for transmitting, to a relay device, a paging configuration associated with the apparatus.

Some aspects described herein relate to an apparatus for wireless communication. The apparatus may include means for receiving, from a UE, a paging configuration associated with the UE and an RRC state associated with the UE. The apparatus may further include means for determining whether to monitor paging occasions for the UE based at least in part on the paging configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3 and 4 are diagrams illustrating example processes associated with system information forwarding in relay, in accordance with the present disclosure.

FIGS. 5 and 6 are diagrams illustrating example processes associated with paging forwarding in relay, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

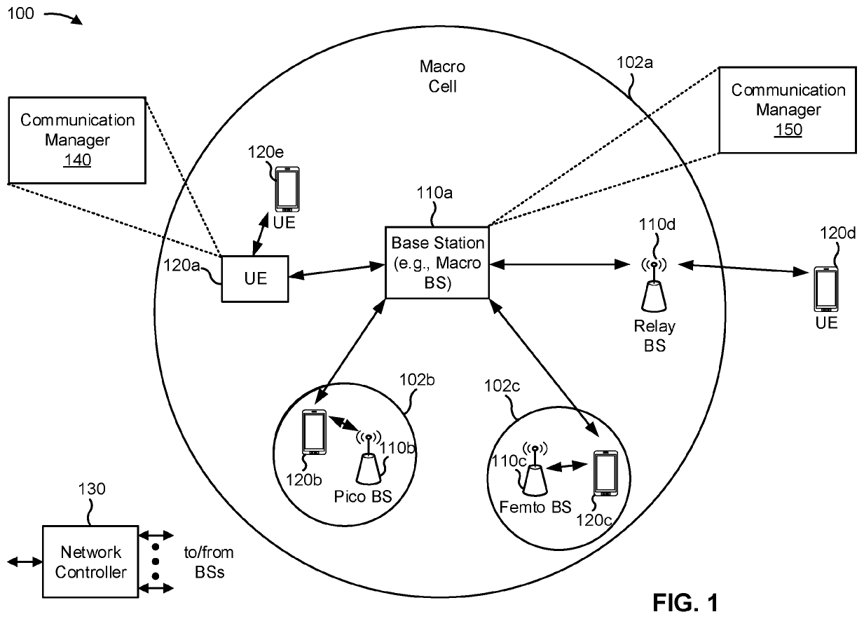

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a relay device associated with a serving cell, a discovery message including a system information block (SIB) with an identifier associated with the serving cell; and determine, using the identifier associated with the serving cell, a global identity (gNB ID) associated with a base station of the serving cell. Additionally, or alternatively, the communication manager 140 may determine a radio resource control (RRC) state associated with the UE 120; and transmit, to a relay device, a paging configuration associated with the UE 120. Additionally, or alternatively, the communication manager 140 may perform one or more other operations described herein.

In some aspects, a relay device (e.g., the base station 110 and/or a UE) may include a communication manager 150. As described in more detail elsewhere herein, the communication manager 150 may receive, from a base station in a serving cell, an SIB including an identifier associated with the serving cell; and transmit, to a UE, a discovery message including the SIB with the identifier. Additionally, or alternatively, the communication manager 150 may receive, from a UE, a paging configuration associated with the UE and an RRC state associated with the UE; and determine whether to monitor paging occasions for the UE based at least in part on the paging configuration. Additionally, or alternatively, the communication manager 150 may perform one or more other operations described herein.

As indicated above, FIG. 1 is provided as an example. Other examples may differ from what is described with regard to FIG. 1.

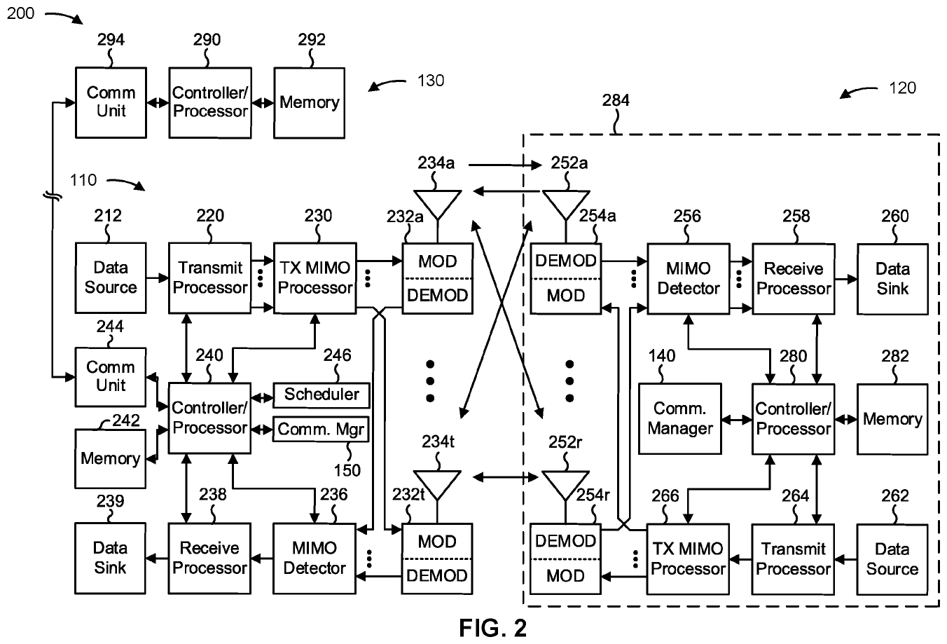

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

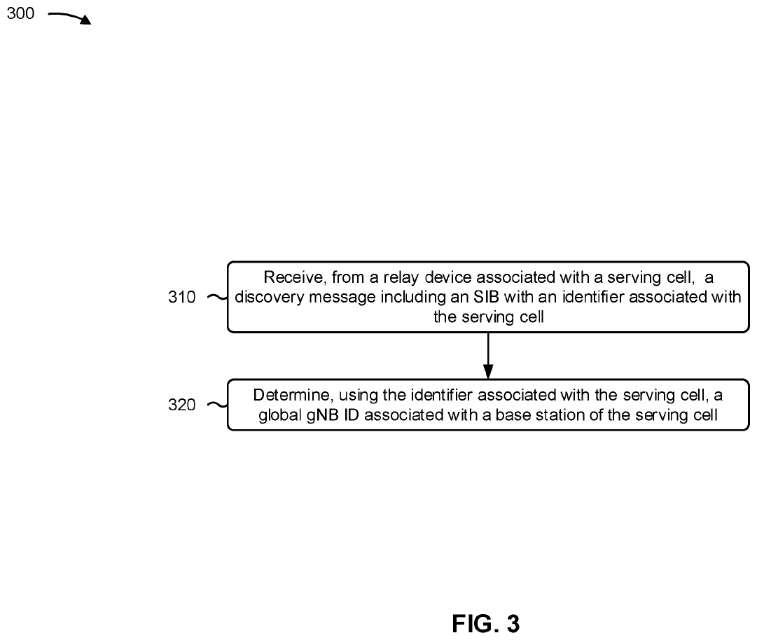

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

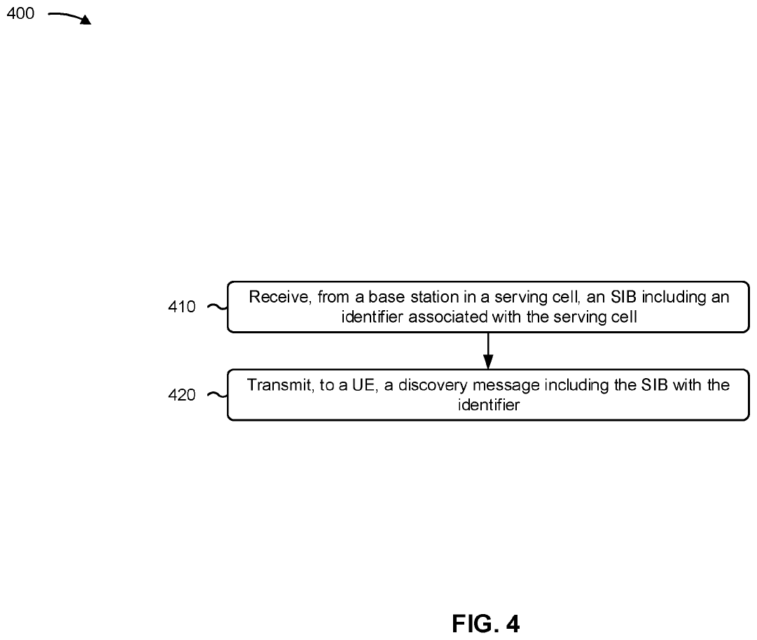

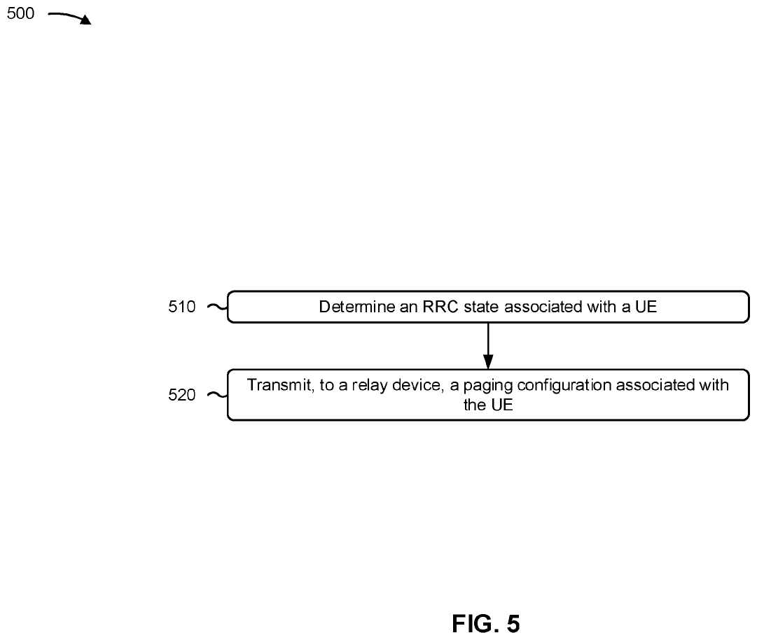

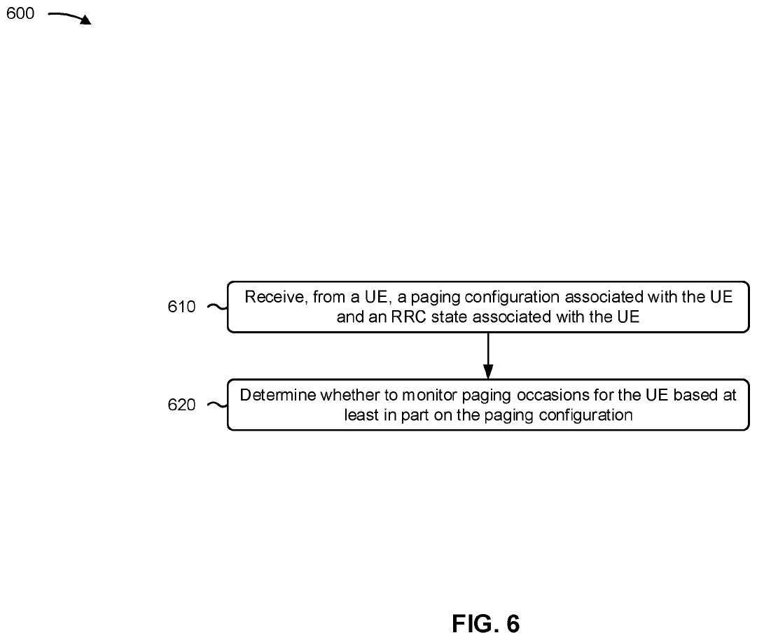

The controller/processor 240 of the base station 110, the controller/processor 280 of the UE 120, and/or any other component(s) of FIG. 2 may perform one or more techniques associated with system information and paging forwarding in relay, as described in more detail elsewhere herein. For example, the controller/processor 240 of the base station 110, the controller/processor 280 of the UE 120, and/or any other component(s) of FIG. 2 may perform or direct operations of, for example, process 300 of FIG. 3, process 400 of FIG. 4, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 300 of FIG. 3, process 400 of FIG. 4, process 500 of FIG. 5, process 600 of FIG. 6, and/or other processes as described herein. In some examples, executing instructions may include running the instructions, converting the instructions, compiling the instructions, and/or interpreting the instructions, among other examples. In some aspects, the relay device described herein is the UE 120, is included in the UE 120, or includes one or more components of the UE 120 shown in FIG. 2. As an alternative, in some aspects, the relay device described herein is the base station 110, is included in the base station 110, or includes one or more components of the base station 110 shown in FIG. 2.

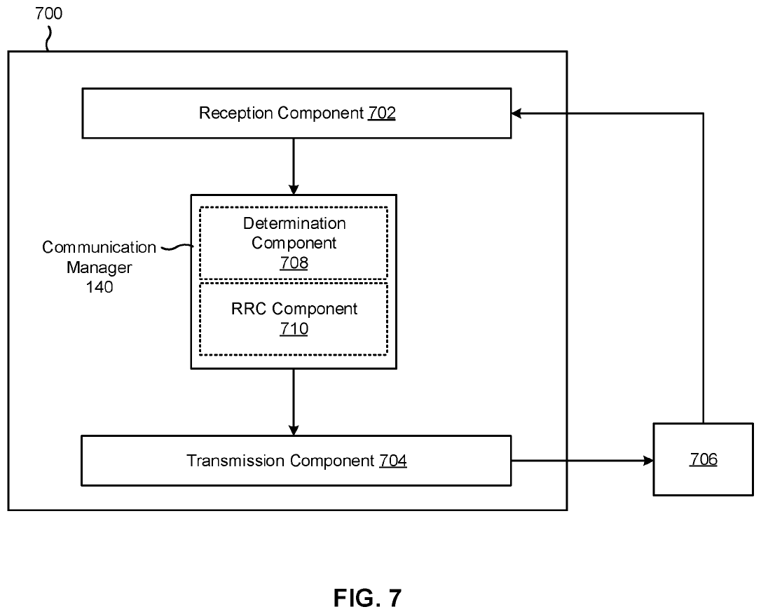

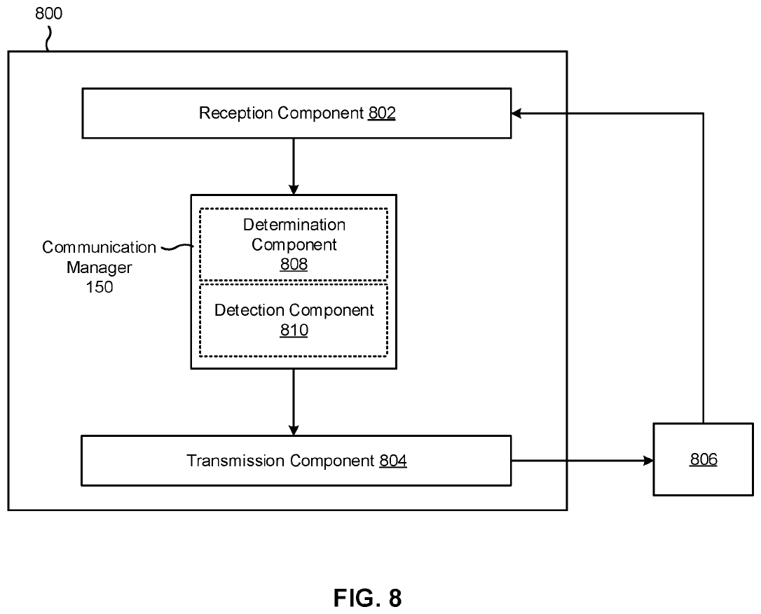

In some aspects, a UE (e.g., the UE 120 and/or apparatus 700 of FIG. 7) may include means for receiving, from a relay device (e.g., the base station 110, another UE, and/or apparatus 800 of FIG. 8) associated with a serving cell, a discovery message including an SIB with an identifier associated with the serving cell; and/or means for determining, using the identifier associated with the serving cell, a global gNB ID associated with a base station of the serving cell (e.g., the base station 110 and/or another base station). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

Additionally, or alternatively, the UE may include means for determining an RRC state associated with the UE; and/or means for transmitting, to the relay device, a paging configuration associated with the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a relay device (e.g., the base station 110, a UE, and/or apparatus 800 of FIG. 8) may include means for receiving, from a base station in a serving cell (e.g., the base station 110 and/or another base station), an SIB including an identifier associated with the serving cell; and/or means for transmitting, to a UE (e.g., the UE 120 and/or apparatus 700 of FIG. 7), a discovery message including the SIB with the identifier. In some aspects, the means for the relay device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. Additionally, or alternatively, the means for the relay device to perform operations described herein may include, for example, one or more of communication manager 140, antenna 252, modem 254, MIMO detector 256, receive processor 258, transmit processor 264, TX MIMO processor 266, controller/processor 280, or memory 282.

Additionally, or alternatively, the relay device may include means for receiving, from the UE, a paging configuration associated with the UE and an RRC state associated with the UE; and/or means for determining whether to monitor paging occasions for the UE based at least in part on the paging configuration. In some aspects, the means for the relay device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. Additionally, or alternatively, the means for the relay device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some situations, a relay device may provide layer 2 (L2) relaying between a UE 120 and a base station 110 (also called “U2N” relay). Accordingly, the relay device implements an adaption layer between the radio link control (RLC), medium access control (MAC), and physical (PHY) layers for the Uu interface with the network to corresponding RLC, MAC, and PHY layers for the PC5 interface with the UE 120.

The relay device may transmit a discovery message such that the UE 120 may establish a connection to the relay device (and thus to the base station serving the relay device). Some techniques and apparatuses described herein enable the relay device to provide a unique identifier associated with the base station in the discovery message. As a result, the UE 120 may use the identifier during cell and/or relay reselection in order to reduce processing and network overhead by reducing chances of switching cells and/or relays.

Additionally, or alternatively, the relay device may monitor paging occasions for the UE 120. Some techniques and apparatuses described herein enable a UE 120 to provide a paging confirmation to the relay device. As a result, the relay device may monitor paging occasions for the UE 120 in order to conserve processing resources and power at the UE 120.

In some aspects, the relay device may transmit a discovery message with a physical cell identity (PCI) and an absolute radio frequency channel number (ARFCN) of a serving gNB. Accordingly, the UE 120 may consider the ARFCN of the serving gNB in cell reselection and/or relay reselection.

In some aspects, the relay device may transmit a discovery message with a global gNB ID. Accordingly, the UE 120 may use the global gNB ID in cell reselection and/or relay reselection.

In some aspects, the relay device may transmit a discovery message with an NR cell identity (NCI) and a length of the global gNB ID. Accordingly, the UE 120 may determine the global gNB ID using the NCI and the length. The relay device may receive the length of the global gNB ID via dedicated RRC signaling. For example, the relay device may include a layer 2 (L2) discovery destination identifier (ID) and the NCI in a SidelinkUEInformationNR data structure such that the gNB validates the L2 discovery destination ID and the NCI and sends the length in an RRC reconfiguration message. In some aspects, the relay device may transmit a discovery message with the NCI, and the UE 120 may use the dedicated RRC signaling to obtain the length of the global gNB ID.

After receiving (or determining) the global gNB ID in the discovery message, the UE 120, in an RRC_CONNECTED state, may perform a cell selection procedure, irrespective of whether the target cell is an intra-gNB or an inter-gNB, when only suitable cells are available. The UE 120 may perform a relay selection procedure and prioritize to select a relay served by the same gNB, when only suitable relays are available. Finally, the UE 120 may perform a cell selection procedure and a relay selection procedure with priority to select a relay served by the same gNB, when both suitable relays and suitable cells are available. The UE 120 may determine whether to use the selected suitable relay or the selected suitable cell based on how the UE 120 is programmed or otherwise preconfigured.

After receiving (or determining) the global gNB ID in the discovery message, the UE 120, in an RRC_INACTIVE state, the UE 120 may prioritize to select a relay served by the same cell (in relay selection) to perform a RAN-based notification area update (RNAU). After receiving (or determining) the global gNB ID in the discovery message, the UE 120, in an RRC_IDLE state, the UE 120 may prioritize to select a relay served by the same cell (in relay selection) to perform a tracking area update (TAU).

In any of the aspects described above, the discovery message may include SIB scheduling information (e.g., for additional SIBs other than SIB1).

Additionally, or alternatively, in some aspects, the UE 120 may transmit a PC5 RRC message to the relay device that includes paging information associated with the UE 120. When the UE 120 is in an RRC_IDLE state, the message indicates the RRC state (RRC_IDLE), a UE ID (e.g., a 5G serving temporary mobile subscriber identity (5G-S-TMSI), and a UE dedicated discontinuous reception (DRX) cycle in a non-access stratum (NAS), if a UE dedicated DRX cycle is configured for the UE 120. When the UE 120 is in an RRC_INACTIVE state, the message indicates the RRC state (RRC_INACTIVE), a 1-bit indication of whether to use the same index of the paging occasion (PO) as for RRC_IDLE, a UE ID (e.g., a 5G-S-TMSI and/or an inactive radio network temporary identifier (I-RNTI)), and a UE dedicated DRX cycle in an NAS, if a UE dedicated DRX cycle is configured for the UE 120. When the UE 120 is in an RRC_CONNECTED state, the message indicates the RRC state (RRC_CONNECTED). Accordingly, the UE 120 transmits updated information to the relay device via a PC5 RRC message upon change of a UE-ID (e.g., 5G-S-TMSI and/or I-RNTI), change of a paging cycle, and/or an RRC state transition.

When the UE 120 disconnects from the relay device (e.g., due to relay reselection and/or cell reselection), the UE 120 transmits a 1-bit indication. Similarly, when the UE 120 determines to monitor its own paging occasions, the UE 120 transmits a 1-bit indication that paging monitoring is not needed.

When the relay device receives information indicating the RRC state of the UE 120 as RRC_IDLE, the relay device starts to monitor the core network (CN) paging of the UE 120. When the relay device receives information indicating the RRC state of the UE 120 as RRC_INACTIVE, the relay device starts to monitor the CN paging and RAN paging of the UE 120. The relay device stops monitoring paging for the UE 120 when the relay device receives information indicating the RRC state of the UE 120 as RRC_CONNECTED, when the relay device receives the UE 120 disconnection indication, when the relay device receives the UE 120 no need of paging forwarding indication, when the relay device detects PC5 radio link failure (RLF) with the UE 120, or when the relay device detects expiry of a keep-alive timer for the link with the UE 120.

FIG. 3 is a diagram illustrating an example process 300 performed, for example, by a UE, in accordance with the present disclosure. Example process 300 is an example where the UE (e.g., UE 120 and/or apparatus 700 of FIG. 7) performs operations associated with system information forwarding in relay.

As shown in FIG. 3, in some aspects, process 300 may include receiving, from a relay device associated with a serving cell, a discovery message including an SIB with an identifier associated with the serving cell (block 310). For example, the UE (e.g., using communication manager 140 and/or reception component 702, depicted in FIG. 7) may receive, from a relay device associated with a serving cell, a discovery message including an SIB with an identifier associated with the serving cell, as described herein.

As further shown in FIG. 3, in some aspects, process 300 may include determining, using the identifier associated with the serving cell, a global gNB ID associated with a base station of the serving cell (block 320). For example, the UE (e.g., using communication manager 140 and/or determination component 708, depicted in FIG. 7) may determine, using the identifier associated with the serving cell, a global gNB ID associated with a base station of the serving cell, as described herein.

Process 300 may include additional aspects, such as any single aspect or any combination of aspects described below and/or in connection with one or more other processes described elsewhere herein.

In a first aspect, the identifier includes a PCI associated with the base station and an ARFCN associated with the base station.

In a second aspect, alone or in combination with the first aspect, the identifier includes the global gNB ID, and determining the global gNB ID includes decoding (e.g., using communication manager 140 and/or reception component 702) the global gNB ID from the SIB.

In a third aspect, alone or in combination with one or more of the first and second aspects, the identifier includes an NCI, and determining the global gNB ID includes receiving (e.g., using communication manager 140 and/or reception component 702) a length of the global gNB ID from the discovery message and determining (e.g., using communication manager 140 and/or determination component 708) the global gNB ID using the NCI and the length.

In a fourth aspect, alone or in combination with one or more of the first through third aspects, the identifier includes an NCI, and determining the global gNB ID includes receiving (e.g., using communication manager 140 and/or reception component 702) a length of the global gNB ID from the base station and determining (e.g., using communication manager 140 and/or determination component 708) the global gNB ID using the NCI and the length.

In a fifth aspect, alone or in combination with one or more of the first through fourth aspects, the length of the global gNB ID is received in an RRC reconfiguration message.

In a sixth aspect, alone or in combination with one or more of the first through fifth aspects, process 300 further includes transmitting (e.g., using communication manager 140 and/or transmission component 704, depicted in FIG. 7), to the base station, an RRC message including an L2 discovery destination ID and the NCI, such that the length of the global gNB ID is received based at least in part on validation of the L2 discovery destination ID and the NCI.

In a seventh aspect, alone or in combination with one or more of the first through sixth aspects, the NCI is received with a handover command during a handover procedure.

In an eighth aspect, alone or in combination with one or more of the first through seventh aspects, the NCI is received with an RRC reestablishment request message to find UE context.

In a ninth aspect, alone or in combination with one or more of the first through eighth aspects, process 300 further includes performing RRC reestablishment (e.g., using communication manager 140 and/or RRC component 710, depicted in FIG. 7) by performing cell selection, without using the global gNB ID, when only suitable cells are available.

In a tenth aspect, alone or in combination with one or more of the first through ninth aspects, process 300 further includes receiving (e.g., using communication manager 140 and/or reception component 702) an RRC connection reject message from the base station with a different global gNB ID.

In an eleventh aspect, alone or in combination with one or more of the first through tenth aspects, process 300 further includes performing RRC reestablishment (e.g., using communication manager 140 and/or RRC component 710) by performing relay selection based at least in part on the global gNB ID when only suitable relays are available.

In a twelfth aspect, alone or in combination with one or more of the first through eleventh aspects, process 300 further includes performing cell selection (e.g., using communication manager 140 and/or RRC component 710) without using the global gNB ID, performing relay selection (e.g., using communication manager 140 and/or RRC component 710) based at least in part on the global gNB ID, and performing RRC reestablishment (e.g., using communication manager 140 and/or RRC component 710) based on the cell selection or the relay selection.

In a thirteenth aspect, alone or in combination with one or more of the first through twelfth aspects, process 300 further includes performing an RNAU (e.g., using communication manager 140 and/or RRC component 710) based at least in part on the global gNB ID.

In a fourteenth aspect, alone or in combination with one or more of the first through thirteenth aspects, process 300 further includes performing a TAU (e.g., using communication manager 140 and/or RRC component 710) based at least in part on the global gNB ID.

In a fifteenth aspect, alone or in combination with one or more of the first through fourteenth aspects, the SIB further includes scheduling information associated with one or more additional SIBs.

Although FIG. 3 shows example blocks of process 300, in some aspects, process 300 may include additional blocks, fewer blocks, different blocks, or differently arranged blocks than those depicted in FIG. 3. Additionally, or alternatively, two or more of the blocks of process 300 may be performed in parallel.

FIG. 4 is a diagram illustrating an example process 400 performed, for example, by a relay device, in accordance with the present disclosure. Example process 400 is an example where the relay device (e.g., apparatus 800 of FIG. 8) performs operations associated with system information forwarding in relay.

As shown in FIG. 4, in some aspects, process 400 may include receiving, from a base station in a serving cell, an SIB including an identifier associated with the serving cell (block 410). For example, the relay device (e.g., using communication manager 150 and/or reception component 802, depicted in FIG. 8) may receive, from a base station in a serving cell, an SIB including an identifier associated with the serving cell, as described herein.

As further shown in FIG. 4, in some aspects, process 400 may include transmitting, to a UE (e.g., UE 120 and/or apparatus 700 of FIG. 7), a discovery message including the SIB with the identifier (block 420). For example, the relay device (e.g., using communication manager 150 and/or transmission component 804, depicted in FIG. 8) may transmit, to a UE, a discovery message including the SIB with the identifier, as described herein.

Process 400 may include additional aspects, such as any single aspect or any combination of aspects described below and/or in connection with one or more other processes described elsewhere herein.

In a first aspect, the identifier includes a PCI associated with the base station and an ARFCN associated with the base station.

In a second aspect, alone or in combination with the first aspect, the identifier includes a global gNB ID.

In a third aspect, alone or in combination with one or more of the first and second aspects, the identifier includes an NCI, and process 400 further includes determining (e.g., using communication manager 150 and/or determination component 808) a global gNB ID by receiving (e.g., using communication manager 150 and/or reception component 802) a length of the global gNB ID from the base station and determining the global gNB ID using the NCI and the length.

In a fourth aspect, alone or in combination with one or more of the first through third aspects, the length of the global gNB ID is received in an RRC reconfiguration message.

In a fifth aspect, alone or in combination with one or more of the first through fourth aspects, process 400 includes transmitting (e.g., using communication manager 150 and/or transmission component 804), to the base station, an RRC message including an L2 discovery destination ID and the NCI, such that the length of the global gNB ID is received based at least in part on validation of the L2 discovery destination ID and the NCI.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a UE, in accordance with the present disclosure. Example process 500 is an example where the UE (e.g., UE 120 and/or apparatus 700 of FIG. 7) performs operations associated with paging forwarding in relay.

As shown in FIG. 5, in some aspects, process 500 may include determining an RRC state associated with the UE (block 510). For example, the UE (e.g., using communication manager 140 and/or determination component 708, depicted in FIG. 7) may determine an RRC state associated with the UE, as described herein.

As further shown in FIG. 5, in some aspects, process 500 may include transmitting, to a relay device (e.g., apparatus 800 of FIG. 8), a paging configuration associated with the UE (block 520). For example, the UE (e.g., using communication manager 140 and/or transmission component 704, depicted in FIG. 7) may transmit, to a relay device, a paging configuration associated with the UE, as described herein.

Process 500 may include additional aspects, such as any single aspect or any combination of aspects described below and/or in connection with one or more other processes described elsewhere herein.

In a first aspect, the paging configuration is transmitted based at least in part on a change in identifier associated with the UE, a change in paging cycle associated with the UE, or a change in the RRC state associated with the UE.

In a second aspect, alone or in combination with the first aspect, the identifier associated with the UE includes a TMSI, an I-RNTI, or a combination thereof.

In a third aspect, alone or in combination with one or more of the first and second aspects, the RRC state includes an idle state, and the paging configuration indicates the RRC state, an identifier associated with the UE, and a dedicated core network paging cycle for the UE.

In a fourth aspect, alone or in combination with one or more of the first through third aspects, the RRC state includes an inactive state, and the paging configuration indicates the RRC state, at least one bit associated with using a same paging occasion index as associated with an idle state of the UE, an identifier associated with the UE, and a RAN paging cycle.

In a fifth aspect, alone or in combination with one or more of the first through fourth aspects, the paging configuration indicates a DRX cycle associated with the UE.

In a sixth aspect, alone or in combination with one or more of the first through fifth aspects, the RRC state includes a connected state, and the paging configuration indicates the RRC state.

In a seventh aspect, alone or in combination with one or more of the first through sixth aspects, process 500 includes transmitting (e.g., using communication manager 140 and/or transmission component 704), to the relay device, at least one bit associated with disconnection of the UE from the relay device.

In an eighth aspect, alone or in combination with one or more of the first through seventh aspects, process 500 further includes transmitting (e.g., using communication manager 140 and/or transmission component 704), to the relay device, at least one bit associated with the relay device not performing paging monitoring for the UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a relay device, in accordance with the present disclosure. Example process 600 is an example where the relay device (e.g., apparatus 800 of FIG. 8) performs operations associated with paging forwarding in relay.

As shown in FIG. 6, in some aspects, process 600 may include receiving, from a (e.g., UE 120 and/or apparatus 700 of FIG. 7), a paging configuration associated with the UE and an RRC state associated with the UE (block 610). For example, the relay device (e.g., using communication manager 150 and/or reception component 802, depicted in FIG. 8) may receive, from a UE, a paging configuration associated with the UE and an RRC state associated with the UE, as described herein.

As further shown in FIG. 6, in some aspects, process 600 may include determining whether to monitor paging occasions for the UE based at least in part on the paging configuration (block 620). For example, the relay device (e.g., using communication manager 150 and/or determination component 810, depicted in FIG. 8) may determine whether to monitor paging occasions for the UE based at least in part on the paging configuration, as described herein.

Process 600 may include additional aspects, such as any single aspect or any combination of aspects described below and/or in connection with one or more other processes described elsewhere herein.

In a first aspect, the paging configuration is received based at least in part on a change in identifier associated with the UE, a change in paging cycle associated with the UE, or a change in the RRC state associated with the UE.

In a second aspect, alone or in combination with the first aspect, the RRC state includes an idle state, and the paging configuration indicates the RRC state, an identifier associated with the UE, and a dedicated core network paging cycle for the UE.

In a third aspect, alone or in combination with one or more of the first and second aspects, the RRC state includes an inactive state, and the paging configuration indicates the RRC state, at least one bit associated with using a same paging occasion index as associated with an idle state of the UE, an identifier associated with the UE, and a RAN paging cycle.

In a fourth aspect, alone or in combination with one or more of the first through third aspects, the paging configuration indicates a DRX cycle associated with the UE.

In a fifth aspect, alone or in combination with one or more of the first through fourth aspects, the RRC state includes a connected state, and the paging configuration indicates the RRC state.

In a sixth aspect, alone or in combination with one or more of the first through fifth aspects, determining whether to monitor paging occasions for the UE includes determining not to monitor paging occasions for the UE based at least in part on the RRC state being a connected state.

In a seventh aspect, alone or in combination with one or more of the first through sixth aspects, process 600 further includes receiving (e.g., using communication manager 150 and/or reception component 802), from the UE, at least one bit associated with disconnection of the UE from the relay device, such that determining whether to monitor paging occasions for the UE includes determining not to monitor paging occasions for the UE based at least in part on the at least one bit.

In an eighth aspect, alone or in combination with one or more of the first through seventh aspects, process 600 further includes receiving (e.g., using communication manager 150 and/or reception component 802), from the UE, at least one bit associated with the relay device not performing paging monitoring for the UE, such that determining whether to monitor paging occasions for the UE includes determining not to monitor paging occasions for the UE based at least in part on the at least one bit.

In a ninth aspect, alone or in combination with one or more of the first through eighth aspects, process 600 further includes detecting (e.g., using communication manager 150 and/or detection component 810, depicted in FIG. 8) RLF with the UE, such that determining whether to monitor paging occasions for the UE includes determining not to monitor paging occasions for the UE based at least in part on the RLF.

In a tenth aspect, alone or in combination with one or more of the first through ninth aspects, process 600 further includes detecting (e.g., using communication manager 150 and/or detection component 810) expiry of a keep alive timer associated with the UE, such that determining whether to monitor paging occasions for the UE includes determining not to monitor paging occasions for the UE based at least in part on expiry of the keep alive timer.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of a determination component 708 and/or an RRC component 710, among other examples.

In some aspects, the apparatus 700 may be configured to perform one or more operations described herein. Additionally, or alternatively, the apparatus 700 may be configured to perform one or more processes described herein, such as process 300 of FIG. 3, process 500 of FIG. 5, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

In some aspects, the reception component 702 may receive (e.g., from the apparatus 706, such as a relay device associated with a serving cell) a discovery message including an SIB with an identifier associated with the serving cell. Accordingly, the determination component 708 may determine, using the identifier associated with the serving cell, a global gNB ID associated with a base station of the serving cell. The determination component 808 may include a modem, a modulator, a demodulator, a MIMO detector, a receive processor, a transmit MIMO processor, a transmit processor, a controller/processor, a memory, or a combination thereof, of the UE described in connection with FIG. 2.

In some aspects, the transmission component 704 may transmit (e.g., to the base station) an RRC message including an L2 discovery destination ID and an NCI. Accordingly, the reception component 702 may receive (e.g., from the base station) a length of the global gNB ID based at least in part on validation of the L2 discovery destination ID and the NCI

In some aspects, the RRC component 710 may perform RRC reestablishment by performing cell selection, without using the global gNB ID, when only suitable cells are available. The RRC component 710 may include one or more antennas, a modem, a modulator, a demodulator, a MIMO detector, a receive processor, a transmit MIMO processor, a transmit processor, a controller/processor, a memory, or a combination thereof, of the UE described in connection with FIG. 2. Additionally, the reception component 702 may receive an RRC connection reject message from the base station with a different global gNB ID. In some aspects, the RRC component 710 may perform RRC reestablishment by performing relay selection based at least in part on the global gNB ID when only suitable relays are available.

In some aspects, the RRC component 710 may perform cell selection without using the global gNB ID. Additionally, the RRC component 710 may perform relay selection based at least in part on the global gNB ID. Accordingly, the RRC component 710 may perform RRC reestablishment based on the cell selection or the relay selection.

In some aspects, the RRC component 710 may perform an RNAU based at least in part on the global gNB ID. In some aspects, the RRC component 710 may perform a TAU based at least in part on the global gNB ID.

Additionally, or alternatively, the determination component 708 may determine an RRC state associated with the apparatus 700. Accordingly, the transmission component 704 may transmit (e.g., to the apparatus 706) a paging configuration associated with the apparatus 700. In some aspects, the transmission component 704 may further transmit (e.g., to the apparatus 706) at least one bit associated with disconnection of the apparatus 700 from the apparatus 706. In some aspects, the transmission component 704 may further transmit (e.g., to the apparatus 706) at least one bit associated with the apparatus 706 not performing paging monitoring for the apparatus 700.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a relay device, or a relay device may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include one or more of a determination component 808 and/or a detection component 810, among other examples.

In some aspects, the apparatus 800 may be configured to perform one or more operations described herein. Additionally, or alternatively, the apparatus 800 may be configured to perform one or more processes described herein, such as process 400 of FIG. 4, process 600 of FIG. 6, or a combination thereof. In some aspects, the apparatus 800 and/or one or more components shown in FIG. 8 may include one or more components of the base station and/or the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station and/or the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station and/or the UE described in connection with FIG. 2. In some aspects, the transmission component 804 may be co-located with the reception component 802 in a transceiver.

In some aspects, the reception component 802 may receive (e.g., from a base station in a serving cell) an SIB including an identifier associated with the serving cell. Accordingly, the transmission component 804 may transmit (e.g., to the apparatus 806, such as a UE) a discovery message including the SIB with the identifier.

In some aspects, the transmission component 804 may further transmit (e.g., to the base station) an RRC message including an L2 discovery destination ID and an NCI. Accordingly, the reception component 802 may receive (e.g., from the base station) a length of a global gNB ID based at least in part on validation of the L2 discovery destination ID and the NCI

Additionally, or alternatively, the reception component 802 may receive (e.g., from the apparatus 806) a paging configuration associated with the apparatus 806 and an RRC state associated with the apparatus 806. Accordingly, the determination component 808 may determine whether to monitor paging occasions for the apparatus 806 based at least in part on the paging configuration. The determination component 808 may include a modem, a demodulator, a MIMO detector, a receive processor, a modulator, a transmit MIMO processor, a transmit processor, a controller/processor, a memory, or a combination thereof, of the base station and/or the UE described in connection with FIG. 2.

In some aspects, the reception component 802 may receive (e.g., from the apparatus 806) at least one bit associated with disconnection of the apparatus 806 from the apparatus 800. Accordingly, the determination component 808 may determine not to monitor paging occasions for the apparatus 806 based at least in part on the at least one bit.

In some aspects, the reception component 802 may receive (e.g., from the apparatus 806) at least one bit associated with the apparatus 800 not performing paging monitoring for the apparatus 806. Accordingly, the determination component 808 may determine not to monitor paging occasions for the apparatus 806 based at least in part on the at least one bit.

In some aspects, the detection component 810 may detect expiry of a keep alive timer associated with the apparatus 806. Accordingly, the determination component 808 may determine not to monitor paging occasions for the apparatus 806 based at least in part on expiry of the keep alive timer. The detection component 810 may include a modem, a demodulator, a MIMO detector, a receive processor, a modulator, a transmit MIMO processor, a transmit processor, a controller/processor, a memory, or a combination thereof, of the base station and/or the UE described in connection with FIG. 2.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, from a relay device associated with a serving cell, a discovery message including a system information block (SIB) with an identifier associated with the serving cell; and determining, using the identifier associated with the serving cell, a global identity (gNB ID) associated with a base station of the serving cell.

Aspect 2: The method of Aspect 1, wherein the identifier includes a physical cell identifier (PCI) associated with the base station and an absolute radio frequency channel number (ARFCN) associated with the base station.

Aspect 3: The method of Aspect 1, wherein the identifier includes the global gNB ID, and wherein determining the global gNB ID comprises decoding the global gNB ID from the SIB.

Aspect 4: The method of Aspect 1, wherein the identifier includes a New Radio cell identity (NCI), and wherein determining the global gNB ID comprises receiving a length of the global gNB ID from the discovery message and determining the global gNB ID using the NCI and the length.

Aspect 5: The method of Aspect 1, wherein the identifier includes a New Radio cell identity (NCI), and wherein determining the global gNB ID comprises receiving a length of the global gNB ID from the base station and determining the global gNB ID using the NCI and the length.

Aspect 6: The method of Aspect 5, wherein the length of the global gNB ID is received in a radio resource control (RRC) reconfiguration message.

Aspect 7: The method of any of Aspects 5 through 6, further comprising: transmitting, to the base station, a radio resource control (RRC) message including a layer 2 (L2) discovery destination identifier (ID) and the NCI, wherein the length of the global gNB ID is received based at least in part on validation of the L2 discovery destination ID and the NCI

Aspect 8: The method of any of Aspects 5 through 7, wherein the NCI is received with a handover command during a handover procedure.

Aspect 9: The method of any of Aspects 5 through 7, wherein the NCI is received with an RRC reestablishment request message to find UE context.

Aspect 10: The method of any of Aspects 1 through 9, further comprising: performing RRC reestablishment by performing cell selection, without using the global gNB ID, when only suitable cells are available.

Aspect 11: The method of Aspect 10, further comprising: receiving an RRC connection reject message from the base station with a different global gNB ID.

Aspect 12: The method of any of Aspects 1 through 9, further comprising: performing RRC reestablishment by performing relay selection based at least in part on the global gNB ID when only suitable relays are available.

Aspect 13: The method of any of Aspects 1 through 9, further comprising: performing cell selection without using the global gNB ID; performing relay selection based at least in part on the global gNB ID; and performing RRC reestablishment based on the cell selection or the relay selection.

Aspect 14: The method of any of Aspects 1 through 13, further comprising: performing a radio access network (RAN) based notification area update (RNAU) based at least in part on the global gNB ID.

Aspect 15: The method of any of Aspects 1 through 13, further comprising: performing a tracking area update (TAU) based at least in part on the global gNB ID.

Aspect 16: The method of any of Aspects 1 through 15, wherein the SIB further includes scheduling information associated with one or more additional SIBs.

Aspect 17: A method of wireless communication performed by a relay device, comprising: receiving, from a base station in a serving cell, a system information block (SIB) including an identifier associated with the serving cell; and transmitting, to a user equipment (UE), a discovery message including the SIB with the identifier.

Aspect 18: The method of Aspect 17, wherein the identifier includes a physical cell identifier (PCI) associated with the base station and an absolute radio frequency channel number (ARFCN) associated with the base station.

Aspect 19: The method of Aspect 17, wherein the identifier includes the global gNB ID, and wherein the method further comprises determining a global identity (gNB ID) associated with the base station by decoding the global gNB ID from the SIB.

Aspect 20: The method of Aspect 17, wherein the identifier includes a New Radio cell identity (NCI), and wherein the method further comprises determining a global gNB ID by receiving a length of the global gNB ID from the base station and determining the global gNB ID using the NCI and the length.

Aspect 21: The method of Aspect 20, wherein the length of the global gNB ID is received in a radio resource control (RRC) reconfiguration message.

Aspect 22: The method of any of Aspects 20 through 21, further comprising: transmitting, to the base station, a radio resource control (RRC) message including a layer 2 (L2) discovery destination identifier (ID) and the NCI, wherein the length of the global gNB ID is received based at least in part on validation of the L2 discovery destination ID and the NCI

Aspect 23: A method of wireless communication performed by a user equipment (UE), comprising: determining a radio resource control (RRC) state associated with the UE; and transmitting, to a relay device, a paging configuration associated with the UE.

Aspect 24: The method of Aspect 23, wherein the paging configuration is transmitted based at least in part on a change in identifier associated with the UE, a change in paging cycle associated with the UE, or a change in the RRC state associated with the UE.

Aspect 25: The method of Aspect 24, wherein the identifier associated with the UE includes a temporary mobile subscriber identity (TMSI), an inactive radio network temporary identifier (I-RNTI), or a combination thereof.

Aspect 26: The method of any of Aspects 23 through 25, wherein the RRC state includes an idle state, and the paging configuration indicates the RRC state, an identifier associated with the UE, and a dedicated core network paging cycle for the UE.

Aspect 27: The method of any of Aspects 23 through 25, wherein the RRC state includes an inactive state, and the paging configuration indicates the RRC state, at least one bit associated with using a same paging occasion index as associated with an idle state of the UE, an identifier associated with the UE, and a radio access network (RAN) paging cycle.

Aspect 28: The method of any of Aspects 26 through 27, wherein the paging configuration indicates a discontinuous reception (DRX) cycle associated with the UE.

Aspect 29: The method of any of Aspects 23 through 25, wherein the RRC state includes a connected state, and the paging configuration indicates the RRC state.

Aspect 30: The method of any of Aspects 23 through 29, further comprising: transmitting, to the relay device, at least one bit associated with disconnection of the UE from the relay device.

Aspect 31: The method of any of Aspects 23 through 29, further comprising: transmitting, to the relay device, at least one bit associated with the relay device not performing paging monitoring for the UE.

Aspect 32: A method of wireless communication performed by a relay device, comprising: receiving, from a user equipment (UE), a paging configuration associated with the UE and a radio resource control (RRC) state associated with the UE; and determining whether to monitor paging occasions for the UE based at least in part on the paging configuration.

Aspect 33: The method of Aspect 32, wherein the paging configuration is received based at least in part on a change in identifier associated with the UE, a change in paging cycle associated with the UE, or a change in the RRC state associated with the UE.

Aspect 34: The method of any of Aspects 32 through 33, wherein the RRC state includes an idle state, and the paging configuration indicates the RRC state, an identifier associated with the UE, and a dedicated core network paging cycle for the UE.

Aspect 35: The method of any of Aspects 32 through 33, wherein the RRC state includes an inactive state, and the paging configuration indicates the RRC state, at least one bit associated with using a same paging occasion index as associated with an idle state of the UE, an identifier associated with the UE, and a radio access network (RAN) paging cycle.

Aspect 36: The method of any of Aspects 34 through 35, wherein the paging configuration indicates a discontinuous reception (DRX) cycle associated with the UE.

Aspect 37: The method of any of Aspects 32 through 33, wherein the RRC state includes a connected state, and the paging configuration indicates the RRC state.

Aspect 38: The method of Aspect 37, wherein determining whether to monitor paging occasions for the UE comprises determining not to monitor paging occasions for the UE based at least in part on the RRC state being a connected state.

Aspect 39: The method of any of Aspects 32 through 38, further comprising: receiving, from the UE, at least one bit associated with disconnection of the UE from the relay device, wherein determining whether to monitor paging occasions for the UE comprises determining not to monitor paging occasions for the UE based at least in part on the at least one bit.

Aspect 40: The method of any of Aspects 32 through 38, further comprising: receiving, from the UE, at least one bit associated with the relay device not performing paging monitoring for the UE, wherein determining whether to monitor paging occasions for the UE comprises determining not to monitor paging occasions for the UE based at least in part on the at least one bit.

Aspect 41: The method of any of Aspects 32 through 38, further comprising: detecting radio link failure (RLF) with the UE, wherein determining whether to monitor paging occasions for the UE comprises determining not to monitor paging occasions for the UE based at least in part on the RLF.

Aspect 42: The method of any of Aspects 32 through 38, further comprising: detecting expiry of a keep alive timer associated with the UE, wherein determining whether to monitor paging occasions for the UE comprises determining not to monitor paging occasions for the UE based at least in part on expiry of the keep alive timer.

Aspect 43: An apparatus for wireless communication at a device, comprising a processor; memory coupled with the processor; and instructions stored in the memory and executable by the processor to cause the apparatus to perform the method of one or more of Aspects 1-16.

Aspect 44: A device for wireless communication, comprising a memory and one or more processors coupled to the memory, the one or more processors configured to perform the method of one or more of Aspects 1-16.

Aspect 45: An apparatus for wireless communication, comprising at least one means for performing the method of one or more of Aspects 1-16.

Aspect 46: A non-transitory computer-readable medium storing code for wireless communication, the code comprising instructions executable by a processor to perform the method of one or more of Aspects 1-16.

Aspect 47: A non-transitory computer-readable medium storing a set of instructions for wireless communication, the set of instructions comprising one or more instructions that, when executed by one or more processors of a device, cause the device to perform the method of one or more of Aspects 1-16.

Aspect 48: An apparatus for wireless communication at a device, comprising a processor; memory coupled with the processor; and instructions stored in the memory and executable by the processor to cause the apparatus to perform the method of one or more of Aspects 17-22.

Aspect 49: A device for wireless communication, comprising a memory and one or more processors coupled to the memory, the one or more processors configured to perform the method of one or more of Aspects 17-22.

Aspect 50: An apparatus for wireless communication, comprising at least one means for performing the method of one or more of Aspects 17-22.

Aspect 51: A non-transitory computer-readable medium storing code for wireless communication, the code comprising instructions executable by a processor to perform the method of one or more of Aspects 17-22.

Aspect 52: A non-transitory computer-readable medium storing a set of instructions for wireless communication, the set of instructions comprising one or more instructions that, when executed by one or more processors of a device, cause the device to perform the method of one or more of Aspects 17-22.

Aspect 53: An apparatus for wireless communication at a device, comprising a processor; memory coupled with the processor; and instructions stored in the memory and executable by the processor to cause the apparatus to perform the method of one or more of Aspects 23-31.

Aspect 54: A device for wireless communication, comprising a memory and one or more processors coupled to the memory, the one or more processors configured to perform the method of one or more of Aspects 23-31.

Aspect 55: An apparatus for wireless communication, comprising at least one means for performing the method of one or more of Aspects 23-31.

Aspect 56: A non-transitory computer-readable medium storing code for wireless communication, the code comprising instructions executable by a processor to perform the method of one or more of Aspects 23-31.

Aspect 57: A non-transitory computer-readable medium storing a set of instructions for wireless communication, the set of instructions comprising one or more instructions that, when executed by one or more processors of a device, cause the device to perform the method of one or more of Aspects 23-31.

Aspect 58: An apparatus for wireless communication at a device, comprising a processor; memory coupled with the processor; and instructions stored in the memory and executable by the processor to cause the apparatus to perform the method of one or more of Aspects 32-42.

Aspect 59: A device for wireless communication, comprising a memory and one or more processors coupled to the memory, the one or more processors configured to perform the method of one or more of Aspects 32-42.

Aspect 60: An apparatus for wireless communication, comprising at least one means for performing the method of one or more of Aspects 32-42.

Aspect 61: A non-transitory computer-readable medium storing code for wireless communication, the code comprising instructions executable by a processor to perform the method of one or more of Aspects 32-42.

Aspect 62: A non-transitory computer-readable medium storing a set of instructions for wireless communication, the set of instructions comprising one or more instructions that, when executed by one or more processors of a device, cause the device to perform the method of one or more of Aspects 32-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive, from a relay device associated with a serving cell, a discovery message with an identifier associated with the serving cell; and
determine, using the identifier associated with the serving cell, a global identity (gNB ID) associated with the serving cell.

2-3. (canceled)

4. The apparatus of claim 1, wherein the identifier includes a New Radio cell identity (NCI), and wherein the one or more processors, to determine the global gNB ID, are configured to receive a length of the global gNB ID from the discovery message and determine the global gNB ID using the NCI and the length.

5. The apparatus of claim 1, wherein the identifier includes a New Radio cell identity (NCI), and wherein the one or more processors, to determine the global gNB ID, are configured to receive a length of the global gNB ID from the serving cell and determine the global gNB ID using the NCI and the length.

6. The apparatus of claim 5, wherein the NCI is received with a handover command during a handover procedure.

7. The apparatus of claim 5, wherein the NCI is received with an RRC reestablishment request message to find UE context.

8. The apparatus of claim 5, wherein the length of the global gNB ID is received in a radio resource control (RRC) reconfiguration message.

9. The apparatus of claim 5, wherein the one or more processors are further configured to:
transmit a radio resource control (RRC) message including a layer 2 (L2) discovery destination identifier (ID) and the NCI,
wherein the length of the global gNB ID is received based at least in part on validation of the L2 discovery destination ID and the NCI.

10. The apparatus of claim 1, wherein the one or more processors are further configured to:
perform RRC reestablishment by performing cell selection, without using the global gNB ID, when only suitable cells are available.

11. The apparatus of claim 10, wherein the one or more processors are further configured to:
receive an RRC connection reject message with a different global gNB ID.

12. The apparatus of claim 1, wherein the one or more processors are further configured to:
perform RRC reestablishment by performing relay selection based at least in part on the global gNB ID when only suitable relays are available.

13. The apparatus of claim 1, wherein the one or more processors are further configured to:
perform cell selection without using the global gNB ID;
perform relay selection based at least in part on the global gNB ID; and
perform RRC reestablishment based on the cell selection or the relay selection.

14. The apparatus of claim 1, wherein the one or more processors are further configured to:
perform a radio access network (RAN) based notification area update (RNAU) based at least in part on the global gNB ID.

15. The apparatus of claim 1, wherein the one or more processors are further configured to:
perform a tracking area update (TAU) based at least in part on the global gNB ID.

16. (canceled)

17. An apparatus for wireless communication at a relay device, comprising:
a memory; and
one or more processors, coupled to the memory, configured to:
receive, from a serving cell, a system information block (SIB) including an identifier associated with the serving cell; and
transmit, to a user equipment (UE), a discovery message including the identifier.

18. (canceled)

19. The apparatus of claim 17, wherein the identifier includes a global identity (gNB ID) associated with the serving cell.

20. The apparatus of claim 17, wherein the identifier includes a New Radio cell identity (NCI), and wherein the one or more processors are configured to determine a global gNB ID by receiving a length of the global gNB ID and determining the global gNB ID using the NCI and the length.

21-22. (canceled)

23. An apparatus for wireless communication at a user equipment (UE), comprising:
a memory; and
one or more processors, coupled to the memory, configured to:
determine a radio resource control (RRC) state associated with the UE; and
transmit, to a relay device, a paging configuration associated with the UE.

24. The apparatus of claim 23, wherein the paging configuration is transmitted based at least in part on a change in identifier associated with the UE, a change in paging cycle associated with the UE, or a change in the RRC state associated with the UE.

25. (canceled)

26. The apparatus of claim 23, wherein the RRC state includes an idle state, and the paging configuration indicates an identifier associated with the UE and a dedicated core network paging cycle for the UE.

27. The apparatus of claim 23, wherein the RRC state includes an inactive state, and the paging configuration indicates an identifier associated with the UE and a radio access network (RAN) paging cycle.

28. The apparatus of claim 23, wherein the paging configuration indicates a discontinuous reception (DRX) cycle associated with the UE.

29-30. (canceled)

31. The apparatus of claim 23, wherein the one or more processors are further configured to:
transmit, to the relay device, at least one bit associated with the relay device not performing paging monitoring for the UE.

32. An apparatus for wireless communication at a relay device, comprising:
a memory; and
one or more processors, coupled to the memory, configured to:
receive, from a user equipment (UE) associated with a radio resource control (RRC) state, a paging configuration associated with the UE; and
determine whether to monitor paging occasions for the UE based at least in part on the paging configuration.

33. The apparatus of claim 32, wherein the paging configuration is received based at least in part on a change in identifier associated with the UE, a change in paging cycle associated with the UE, or a change in the RRC state associated with the UE.

34. The apparatus of claim 32, wherein the RRC state includes an idle state, and the paging configuration indicates an identifier associated with the UE and a dedicated core network paging cycle for the UE.

35. The apparatus of claim 32, wherein the RRC state includes an inactive state, and the paging configuration indicates an identifier associated with the UE and a radio access network (RAN) paging cycle.

36. The apparatus of claim 32, wherein the paging configuration indicates a discontinuous reception (DRX) cycle associated with the UE.

37-39. (canceled)

40. The apparatus of claim 32, wherein the one or more processors are further configured to:
receive, from the UE, at least one bit associated with the relay device not performing paging monitoring for the UE,
wherein the one or more processors, to determine whether to monitor paging occasions for the UE, are configured to determine not to monitor paging occasions for the UE based at least in part on the at least one bit.

41. The apparatus of claim 32, wherein the one or more processors are further configured to:
detect radio link failure (RLF) with the UE,
wherein the one or more processors, to determine whether to monitor paging occasions for the UE, are configured to determine not to monitor paging occasions for the UE based at least in part on the RLF.

42. The apparatus of claim 32, wherein the one or more processors are further configured to:
detect expiry of a keep alive timer associated with the UE,
wherein the one or more processors, to determine whether to monitor paging occasions for the UE, are configured to determine not to monitor paging occasions for the UE based at least in part on expiry of the keep alive timer.
